(19) United States
(12) Patent Application Publication
(10) Pub. No.: US 2026/0351693 A1
(43) Pub. Date: Nov. 5, 2026

(54) TRACTION BATTERY BASED ON LITHIUM-TITANIUM-OXIDE CELLS FOR AUTONOMOUS HIGHLY AUTOMATED VEHICLES

(71) Applicant: OBSHCHESTVO S OGRANICHENNOI OTVETSTVENNOSTIU "EVOKARGO", Moscow (RU)

(72) Inventors: Lev Nikolaevich Butov, Moscow (RU); Pavel Vladimirovich Pyrkov, Kuznetsk (RU); Anastasiya Borisovna Bocharova, pgt. Afipskij (RU); Ilya Mihajlovich Fedichev, Moscow (RU); Anton Dmitrievich Poppel, Moscow (RU); Dmitrii Sergeevich Kolesnikov, Moscow (RU); Oleg Sergeevich Shipitko, Moscow (RU); Andrej Sergeevich Bolshakov, Moscow (RU)

(21) Appl. No.: 19/125,449

(22) PCT Filed: Nov. 24, 2023
(86) PCT No.: PCT/RU2023/050273

§ 371 Date: Apr. 29, 2025

(30) Foreign Application Priority Data
Nov. 29, 2022 (RU) 2022130933

(51) Int. Cl. H01M 10/42; B60L 50/64; B60L 58/10; H01M 4/485; H01M 10/48; H01M 50/209; H01M 50/249

(52) U.S. Cl. CPC H01M 10/425; B60L 50/64; B60L 58/10; H01M 4/485; H01M 10/482; H01M 10/486; H01M 50/209; H01M 50/249; H01M 2010/4271; H01M 2220/20

(57) ABSTRACT

A traction battery based on lithium-titanium-oxide cells for autonomous highly automated vehicles that comprises a body, which contains electrically interconnected modules, each of the modules containing serially interconnected battery cells, which are electrically insulated from each other, wherein the battery cells are lithium-titanium-oxide based cells, which can operate at temperatures between −30 °C and +50 °C; and the body contains a monitoring system comprising at least two temperature sensors mounted on each module, voltmeters for each cell in a module, a total current controller, and modules for monitoring and controlling the state of the serially and parallelly connected battery modules and the battery as a whole.

### FIELD OF INVENTION

The proposed invention relates to electrical engineering, particularly to a traction battery based on lithium-titanium-oxide cells for autonomous highly automated vehicles, designed for accumulating and storing electrical energy that is used to provide power to a vehicle and its low-voltage on-board consumers.

### DESCRIPTION OF THE PRIOR ART

There are many known types of traction batteries with different chemical processes of energy accumulation. The present solution of a traction battery based on lithium-titanium-oxide cells has a number of advantages over the prior art.

There is a battery known from DE 102011113798 A1, H01M10/48, made public on May 3, 2012, that consists of a series and parallel connections of battery modules, each connected to a switching module, a local battery management module, and internal battery sensors. The switching module which can turn on and off the battery module is composed of a parallel-acting relay and circuit breaker; the data from the sensors (such as voltage and temperature in the battery module) and from the local management module are transmitted and sent to a central management module connected to a safety management module, which analyzes the data from the external and internal battery sensors and generates a switch-off signal in case of error or warning signals, so that all switching modules break the circuits.

The drawbacks of this solution include the arrangement of the sensors, which are located only on modules rather than on each cell, which, in case of a local error/defect, would require a replacement/repair/examination of the whole module; and the clutter, as the sensors, switching modules, and local management modules are located by each module, which depletes the space that could otherwise accommodate more cells, whereas the excessive number of modules is also detrimental to ergonomics, thus, in turn, reducing capacity.

Another traction battery device is known from US 2022278353 A1, H01M10/04, made public on Sep. 1, 2022, which is comprised on a stack of serially connected battery cells clamped together by two end plates and an anchor board. The anchor board may contain a board body that carries electronic elements and an anchor bolt, both comprising a single element. Thanks to the electronic elements, the anchor board can be used to contact individual battery cells. In addition, the board body can be made of a material with low thermal expansion and have both a thermally and also electrically insulating and, further, flame-retardant effect, which advantageously favors the operational safety of a battery device.

The drawbacks of this solution include the fact that it is impossible to efficiently replace the cells when necessary and the lack of control/monitoring modules for data collection and analysis.

Yet another battery system, considered to be the closest prior art, is known from RU 2648979 C2, H01M10/42, made public on Mar. 29, 2018, comprises a number of battery elements, electrically connected to each other, each element containing several electrochemical individual cells, wherein each of the battery elements is thermally isolated from other such elements. Each of the electrochemical individual cells contains a monitoring device, adapted to electrically disconnect the battery element from other battery elements in case at least one measurement that is monitored by the monitoring device lies outside the specified range. The improvement of this invention is an improved safety of the battery system, achieved by thermally isolating each battery element from other such elements and adapting the monitoring device to monitor certain parameters and disconnect faulty elements. After the faulty elements have been disconnected, the battery system can still be used, albeit with a slightly reduced power.

The drawback of the prior art is insufficient capacity due to serial arrangement of individual cells inside the element. Besides, the known system does not disclose the composition of the sensors and their relative locations.

### SUMMARY OF THE INVENTION

The technical problem to be solved by the proposed invention is to create a traction battery based on lithium-titanium-oxide cells to be used in autonomous highly automated vehicles.

The objective of the proposed invention is to provide increased capacity, service life, and improved safety of a traction battery.

The objective is achieved by a traction battery based on lithium-titanium-oxide cells for autonomous highly automated vehicles that comprises a body, which contains electrically interconnected modules, each of the modules containing serially interconnected battery cells, which are electrically insulated from each other, wherein the battery cells are lithium-titanium-oxide based cells, which can operate at temperatures between −30 °C and +50 °C; and the body contains a monitoring system comprising at least two temperature sensors mounted on each module, voltmeters for each cell in a module, a total current controller, and modules for monitoring and controlling the state of the serially and parallelly connected battery modules and the battery as a whole.

The technical solutions used in the proposed battery allow to monitor the main parameters of the state of each individual cell and all the modules as a whole, while the connections are made in such a way that there is no need for additional buffer battery systems or heating systems. Serial connection of cells in modules allows to achieve an increased nominal voltage, while a combination of serial and parallel connections of modules results in an increased current and capacity of the battery.

### BRIEF DESCRIPTION OF THE DRAWINGS

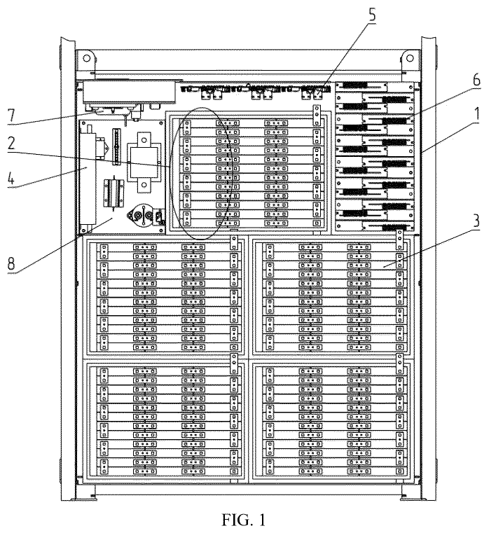

FIG. 1 illustrates a structural diagram of a traction battery, in which:
1—traction battery (EVB) body;
2—EVB battery module;
3—lithium-titanium-oxide (LTO) based cell;
4—board powering converter;
5—monitoring and control modules;
6—cell control boards;
7—fuse connector;
8—high-voltage connection module.

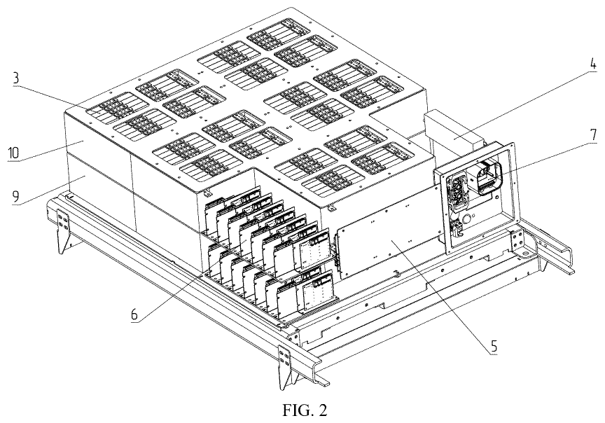

FIG. 2 illustrates a traction battery model, in which:
3—lithium-titanium-oxide (LTO) based cell;
4—board powering converter;
5—monitoring and control modules;
6—cell control boards;
7—fuse connector;
9—tier 1 polymer housing;
10—tier 2 polymer housing.

The EVB body (1) comprises battery modules (2), which, in turn, are composed of serially connected lithium-titanium-oxide based cells (3), each of which is connected via an electric contact to the control board (6), which is part of the battery system monitoring and control modules (5). At the same time, no more than three modules (each module consists of 12 serially connected cells) are combined into a unit and placed into a polymer housing made of a thermally conductive material that serves to remove hear from the modules. The proposed invention comprises at least two polymer housings arranged in two tiers (9, 10). The cell control boards (6) are powered by means of the converter (4) that receives energy from the EVB battery modules (2). The board powering converter (4) is connected to the fuse connector (7), which allows to stop all processed in the EVB when it is removed. A special high-voltage connection (8) is used to connect the high voltage inside the EVB. The amount of charge is monitored by the monitoring and control modules (5) that collect and analyse data from each EVB battery module (2). The temperature is registered by at least two thermal sensors installed in each EVB battery module (2), which provide a more precise monitoring, whereas the prior art uses only one thermal sensor that is capable of measuring temperature in one spot only, the voltage on each cell (3) is measured by the control board (6), and all the measurements (voltage, temperature, amount of charge) are displayed on a connected computer via a Web interface.

### DETAILED DESCRIPTION OF THE INVENTION

The state of the cells is monitored by means of monitoring and control systems of the traction battery, installed as part of the EVB, and since the 168S2P (168 serially connected cells, 2 parallelly connected tiers) connection is used, a system for controlling parallel battery arrays is additionally implemented, providing logical control circuits that ensure safe operation and maintenance of batteries with a voltage of more than 400 V. In order to achieve the voltage and capacity required for the operation of a highly automated vehicle (HAV), the following design has been developed: 12 cells with a nominal voltage of 2.3 V and capacity of 20 Ah are serially connected and make up one module, and at least three such modules are combined into a unit so as to make it easier to repair and/or replace the modules (see FIG. 1). Further, at least four said units are also serially connected into a single battery tier with the following parameters: 331.2 V and 20 Ah. In order to increase the capacity (HAV's operating time), two such tiers have been made, which are parallelly connected (see FIG. 2). Thus, the final battery assemble has the following parameters: nominal voltage—331.2 V, capacity—40 Ah (which allows to operate the HAV for 6 hours at temperatures between −30 °C and +50 °C). Such a design allows to charge each of the tiers simultaneously via an external direct current source. The advantage of this assembly is that each cell balances itself (due to potential equalization in each cell). The system is monitored via a Web interface for each of the tiers. This allows to monitor voltage, temperature, current, charge, errors, and capacity for each of the cells, as well as the total charge, number of cycles, state of charge, and current for each of the tiers. 100 A fuses are provided in the EVB to protect it against current surges between the tiers. There are also two contactors between the tiers that are controlled by the control boards of both tiers. Each of the tiers has its own control board.

The chemical basis of cells (lithium-titanium-oxide anode) that make up the traction battery allows to conduct discharging with a current of up to 6 C and charging with a current of 3 C, where C is the capacity of the whole system. In addition, the lithium-titanium-oxide based system has stable performance within a wide range of temperatures between −30 °C and +50 °C, thus eliminating the need to implement a heating and/or cooling system in the traction battery, which is required when working with systems of a different type, if the ambient temperature does not match the standard range between 0 °C and +50 °C for other commercial lithium-ion batteries.

Thus, the proposed traction battery based on lithium-titanium-oxide cells provides an increased capacity due to serial and parallel arrangement of battery cells and modules, an increased service life due to the chemical-based cells, and an improved safety, which is ensured by the control system in each module and the chemical-based cells that make up the traction battery, which, in turn, makes it possible to charge and discharge the battery in a wide temperature range between −30 °C and +50 °C without heating systems.

The proposed traction battery based on lithium-titanium-oxide cells is used as a power source for autonomous highly automated vehicles.

The proposed invention meets the industrial applicability criterion and can be implemented on any ground-based autonomous highly automated vehicles.

What is claimed is:

1. A traction battery based on lithium-titanium-oxide cells for autonomous highly automated vehicles, the battery comprising a body, which contains electrically interconnected modules, each of the modules containing serially interconnected battery cells, which are electrically insulated from each other, characterized in that the battery cells are lithium-titanium-oxide based cells, which can operate at temperatures between −30 °C and +50 °C; and the body contains a monitoring system comprising at least two temperature sensors mounted on each module, voltmeters for each cell in a module, a total current controller, and modules for monitoring and controlling the state of the serially and parallelly connected battery modules and the battery as a whole.
